(19) United States
(12) Patent Application Publication
(10) Pub. No.: US 2004/0190629 A1
(43) Pub. Date: Sep. 30, 2004

(54) System and method for broadcast of independently encoded signals on atsc channels

(76) Inventors: Jeffrey Allen Cooper, Rocky Hill, NJ (US); Kumar Ramaswamy, Plainsboro, NJ (US); Paul Gothard Knutson, Lawrenceville, NJ (US)

Correspondence Address: Joseph S Tripoli, Thomson Licensing Inc, Patent Department, P O Box 5312, Princeton, NJ, 08543-5312, US

(21) Appl. No.: 10/484,567

(22) PCT Filed: Jul. 19, 2002
(86) PCT No.: PCT/US02/23031

(51) Int. Cl. H04N 7/12

(52) U.S. Cl. 375/240.26; 375/240.08

(57) ABSTRACT

The ATSC standard for digital television broadcast specifies a data Channel in addition to the normal audio and video channels. A methodology is provided for using the ATSC data Channel to broadcast MPEG-4 video streams, for which a new video service is created. The MPEG-4 streams can be encapsulated into MPEG-2 PES (Packetized Elementary Streams) packets or directly into MPEG-2 transport packets. These mechanisms enable the synchronous broadcast of MPEG-4 streams for an ATSC digital TV system without a change to the ATSC standard when data casting. In a system for transmission of video and audio information, in which the system is constrained to operate pursuant to a given standard, including application of a given coding methodology, transmission of the information using a coding methodology that is independent of the coding methodology is provided through encoding the information into a plurality of increments encoded according to the independent coding methodology; and encapsulating the encoded information increments into a payload portion of transmission packets established according to the given standard.

### RELATED APPLICATION

This application claims the benefit of U.S. Provisional Patent Application Serial No. 60/307,201 filed on Jul. 23, 2001 and entitled BROADCAST OF MPEG-4 ON ATSC TERRESTRIAL CHANNELS, which is incorporated by reference herein in its entirety.

### FIELD OF THE INVENTION

The invention relates generally to digital video broadcasting, and more particularly to the application of advanced coding methods for digital video signals.

### BACKGROUND OF THE INVENTION

Continually increasing demand for video throughput in a finite transmission infrastructure has been met by increasingly powerful compression algorithms and the development of corresponding improvements in digital processing capability needed to effectively implement such compression methods. In the operation of the compression process, digitized video signal information is operated on by an encoder at the transmission site, which carries out the desired compression algorithms and produces as an output a video bitstream requiring substantially less transmission bandwidth than would have been required for the original video signal information. After transmission of that compressed video bitstream to a receiving site, that bitstream is operated on by a decoder which reverses the compression process and restores the original video signal information.

The current standard for digital television broadcasting in the United States, as promulgated by the Advanced Television Systems Committee (ATSC), uses MPEG-2 (Moving Picture Experts Group) based video and audio compression for broadcasting HDTV (high definition television) services. However, only one HDTV service or up to six standard definition services can be supported on a 6 MHz channel using MPEG-2 based compression. The use of advanced video compression techniques (such as MPEG-4) would allow the same 6 MHz channel to be at least twice as efficient. For example, 2 high definition channels, or up to 12 standard definition channels, could be carried on one 6 MHz channel. In addition, MPEG-4 supports low bit rate channels for transmitting signals to devices with small display devices. By contrast, MPEG-2 is significantly less efficient for sending transmissions with low bit rates. With MPEG-4 part 10 coding, it is possible to send quarter-VGA resolution with high quality at 400 Kbps. Since quarter-VGA resolution is approximately VCR quality, 50 such channels could be sent on one ATSC 6 MHz channel.

In addition, the advanced error resiliency and scalability tools used for MPEG-4 permit the creation of a robust video distribution system that is typically difficult for devices operating with low bit rates. However, because the ATSC standard is constrained to operation with MPEG-2 coding, the advantages of MPEG-4 are not realizable with ATSC digital video of the present art.

### SUMMARY OF INVENTION

The ATSC standard for digital television broadcast specifies a Data Channel in addition to the normal audio and video channels. A methodology is provided for using the ATSC Data Channel to broadcast MPEG-4 video streams, for which a new video service can be created. The MPEG-4 streams can be encapsulated into MPEG-2 PES (Packetized Elementary Stream) packets or directly into MPEG-2 transport packets. These mechanisms enable the synchronous broadcast of MPEG-4 streams for an ATSC digital TV system without a change to the ATSC standard when data casting. An embodiment of the invention uses an ATSC terrestrial transmission system for broadcasting MPEG-4 video and audio streams for mobile and non-mobile receivers.

### BRIEF DESCRIPTION OF THE DRAWINGS

FIG. 1 is a high-level schematic depiction of an ATSC broadcast system;

FIG. 2 is a high-level schematic depiction of the ATSC broadcast system modified to operate in accordance with the method of the invention;

FIG. 3 provides a schematic depiction of a method for encapsulating MPEG-4 data into packets of an ATSC transport stream according to one embodiment of the invention;

FIG. 4 provides a schematic depiction of a method for encapsulating MPEG-4 data into packets of an ATSC transport stream according to a second embodiment of the invention; and

FIG. 5 provides a schematic depiction of a method for encapsulating MPEG-4 data into packets of an ATSC transport stream according to a third embodiment of the invention.

### DETAILED DESCRIPTION OF THE NVETION

In the United States, HDTV and other advanced television services are provided pursuant to standards promulgated by the Advanced Television Systems Committee (ASTC), the basic such standard being ASTC Standard A/53, ASTC Digital Television Standard. Additionally, and as heretofore noted in the Background section, the encoding and transmission of digital television signals in an ASTC advanced television system is carried out pursuant to a standard promulgated by the Motion Picture Experts Group known as MPEG-2, and officially designated as International Standard ISO/IEC 13818, Infornation Technology—Generic Coding of Moving Pictures and Associated Audio Information. (It is noted that U.S. HDTV follows a different standard for audio coding than MPEG-2, but that difference is not material to the discussion herein.)

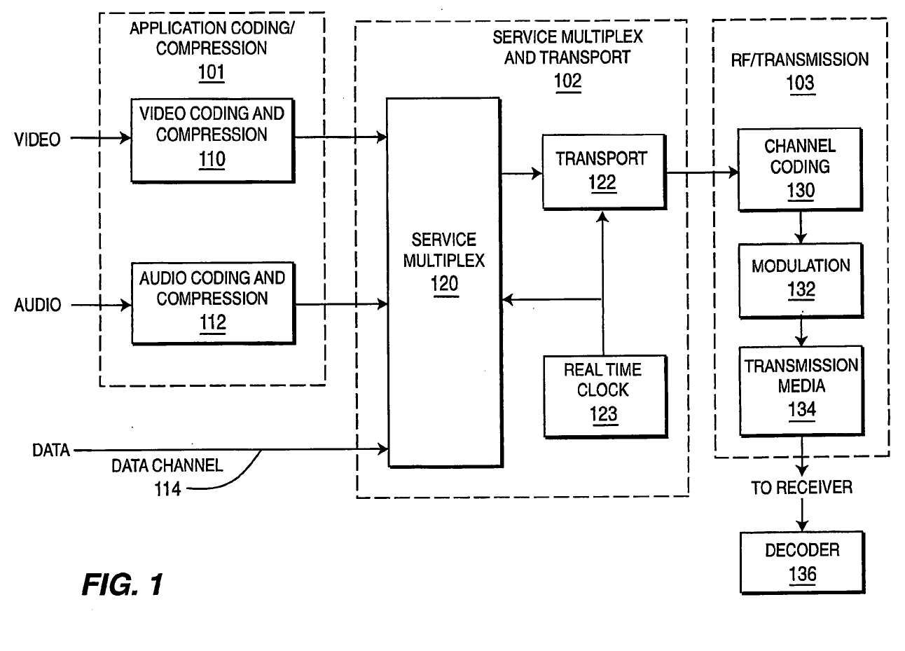

A high-level schematic illustration of the main subsystems of the ATSC advanced television systems is shown in FIG. 1. As can be seen in the figure, that system encompasses an Application (video/audio) Coding and Compression subsystem 101, a Service Multiplex And Transport subsystem 102 and an RF/Transmission subsystem 103. The application coding and compression subsystem includes Video Coding and Compression 110 and Audio Coding and Compression 112, which are provided pursuant to the ATSC A/53 standard. Other than to note that the video application is based on the MPEG-2 standard and that the particulars of these input functions are well known to those skilled in the art, no further discussion of the ASTC video and audio coding and compression functions is needed here.

A Data Channel 114 is also provided as an input to the system in accordance with ATSC Standard A/90, ATSC Data Broadcast Standard. Although some form of encoding and/or compression may be applied for data input to the system using the Data Channel, such encoding/compression is outside the scope of the Standard, and is accordingly not shown in the figure. Operation of the Data Channel will be described in more detail below.

The Service Multiplex function 120 of the Service Multiplex and Transport subsystem operates to divide the digital data stream into packets of information, including a unique identification of each packet or packet type, along with multiplexing video stream packets, audio stream packets and data stream packets into a single transport stream. The Transport function 122 employs the MPEG-2 transport stream protocols and will also be described in more detail below. Real Time Clock 123 provides a timing reference for the Transport 122 and Service Multiplex 120 functions in accordance with well known principles.

The RF/Transmission subsystem (103), which includes Channel Coding function 130, Modulation function 132 and Transmission Media 134, carries out functions well known to those skilled in the art and need not be further described here. An output signal from the RF/Transmission subsystem is transmitted to a receiver (having a decoder 136) and the signal is demodulated, decoded and decompressed to recover the original signal information.

The ATSC Transport function is based on the MPEG-2 system specification, including the use of fixed-length packets that are identified by headers. Each header identifies a particular application bit stream, also called an elementary bit stream, which forms the payload of the packet. Supported applications included video, audio, data, program and system control information. The elementary bit streams for video and audio are themselves wrapped in a variable-length packet structure called the packetized elementary stream (IPES) before transport processing. Elementary bit streams sharing a common time base are multiplexed into programs.

The ATSC transport function also follows the MPEG-2 system coding specification wherein the elementary streams may be multiplexed into either a Program Stream or a Transport Stream. A Program Stream results from combining one or more streams of PES packets, having a common time base, into a single stream. A Tranisport Stream combines one or more programs with one or more independent time bases into a single stream. The Transport Stream is also designed for use in environments where errors are likely, such as transmission in lossy or noisy media.

Data transmitted via the ATSC Data Channel 114 (pursuant to ATSC Standard A/90) is encapsulated into the payload of MPEG-2 Transport Stream packets. Various data transmission methodologies are contemplated by the A/90 Standard, including Synchronous Data Streaming and Data Piping. Synchronous Data Streaming is defined in the Standard as the streaming of data with timing requirements, in the sense that the data and clock can be regenerated at the receiver into a synchronous data stream. Synchronous data streams have no strong timing association with other data streams and are carried in PES packets. Data Piping is defined by the standard as a mechanism for delivery of arbitrary user-defined data inside an MPEG-2 Transport Stream. With Data Piping, data is inserted directly into the payload of MPEG-2 Transport Stream packets.

In accordance with the principles of the present invention, the data channel is adapted to accept MPEG-4 video streams, creating a new type of video service available for ATSC broadcasts. The compression efficiency of MPEG-4 can then be used to create more data channels, as well as to transmit data on channels with a very low bit rate for devices with smaller display sizes (that otherwise wouldn't be able to accommodate video services).

Video transmissions via the ATSC/MPEG-2 standard are restricted to video resolutions between a CCIR601 standard definition and an HDTV resolution. This contrasts with the use of MPEG-4 streams on the ATSC data channel in accordance with the principles of the present invention, which will support any video frame resolution, including small handheld sized type displays using resolution formats such as QCIF (Quarter Common Interchange Format) or CIF (Common Intermediate Format).

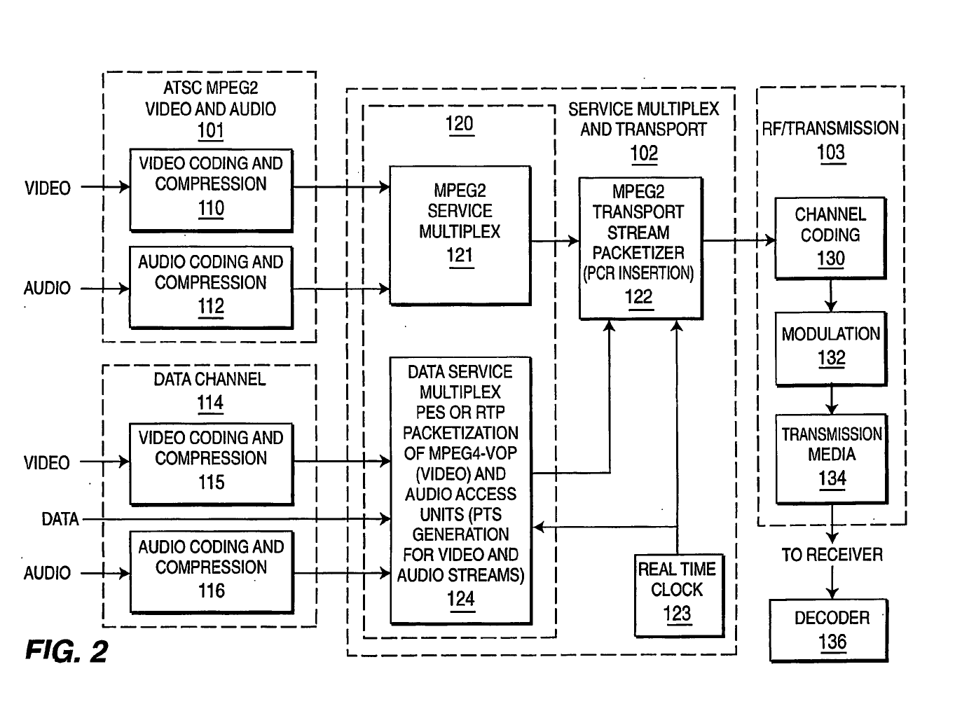

FIG. 2 shows a high-level schematic illustration for an encoder system arranged to implement the principles of the present invention. Common reference numbers are used in that figure for functions corresponding to the systems and subsystems depicted in FIG. 1. Except as warranted to explain the method of the invention, no further explanation is provided here of such common functions. With reference to the figure, and particularly to the Data Channel 114, it can be seen that additional Video Coding and Compression 115 and Audio Coding and Compression 116 functions are provided for information transmitted via the Data Channel. In an exemplary embodiment of the invention, such video and audio coding and compression (115 and 116) is carried out using the MPEG4 methodology, where the new information is encoded into Video Object Pictures (VOP) in accordance with the MPEG-4 scheme.

As will also be seen from the figure, the Service Multiplex function 120 includes both an MPEG-2 Service Multiplex 121, which operates to carry out the typical prior art MPEG-2 processing, and a Data Service Multiplex 124, which receives a stream of MPEG-4 VOPs from the MPEG-4 video encoder 115. The Service Multiplex 124 uses either PES packets or RTP (Real Time Protocol) packets to encapsulate the MPEG-4 VOPs and the Audio access units into separate PES or RTP streams. The process of such packetization of MPEG-4 units according to the method of the invention is described in detail below.

The output of Data Service Multiplex 124 is provided to Transport Stream Packetizer 122 for insertion of the multiplexed MPEG4 VOP information into the MPEG-2 transport stream. In an exemplary embodiment of the invention, the MPEG-2 Transport Stream Packetizer segments the data streams into 188 byte packets, assigns PDs (audio and video unique PIDs), multiplexes the various streams (audio, video, data), and inserts PCR values every 100 msec or less (as specified by the ATSC standard). Of course, the MPEG-2 transport layer also serves its other typical prior art functions, as specified by the ATSC standard (synch byte, continuity counter, etc.).

As will be readily understood by those skilled in the art, a decoder 136 established to operate pursuant to the principles of the present invention will, in addition to its normal operation in respect to receiving and decoding the MPEG-2 transport stream, include a further processing capability directed to the recovery and decoding of the MPEG-4 data encapsulated in the MPEG-2 transport stream.

MPEG-4 video streams may be encapsulated into the ATSC standard data broadcast syntax in multiple formats. In two preferred embodiments of the invention, the broadcast of MPEG-4 streams via the data channel is achieved by the methods of Synchronous Data Streaming or Data Piping.

A key function of the service multiplex layer of FIG. 2 is to attach audio and video PTS values synchronously with the transport layer of the system. When Synchronous Data Streaming is used, the PES layer performs this function; correspondingly, when Data Piping is used, RTP performs this function.

Considering now in detail the packetization of MPEG-4 units in accordance with the principles of the present invention, the Synchronous Data Streaming embodiment uses the MPEG-2 PES and transport stream packet formats. Each MPEG-4 video object picture (VOP) is encapsulated in a variable length PES packet. Therefore, each PES packet begins with an MPEG-4 VOP. These PES packets are, in turn, encapsulated into MPEG-2 transport packets. With this method, the PES packets are required to be aligned at the start of a transport packet. This causes zero stuffing to be added to every VOP period. The stuffing is implemented using MPEG-2 transport packet adaptation fields. This stuffing is used since the MPEG-2 transport packets are of fixed length; therefore zero stuffing is placed between the end of an MPEG-4 VOP and the beginning of the next MPEG-4 VOP at the beginning of the next MPEG-2 transport packet. The packet alignment of MPEG-4 VOPs facilitates easier VOP location at the receiver, since the receiver can simply look at the beginning of each MPEG-2 TS packet to determine if a PES packet exists (and therefore an MPEG-4 VOP).

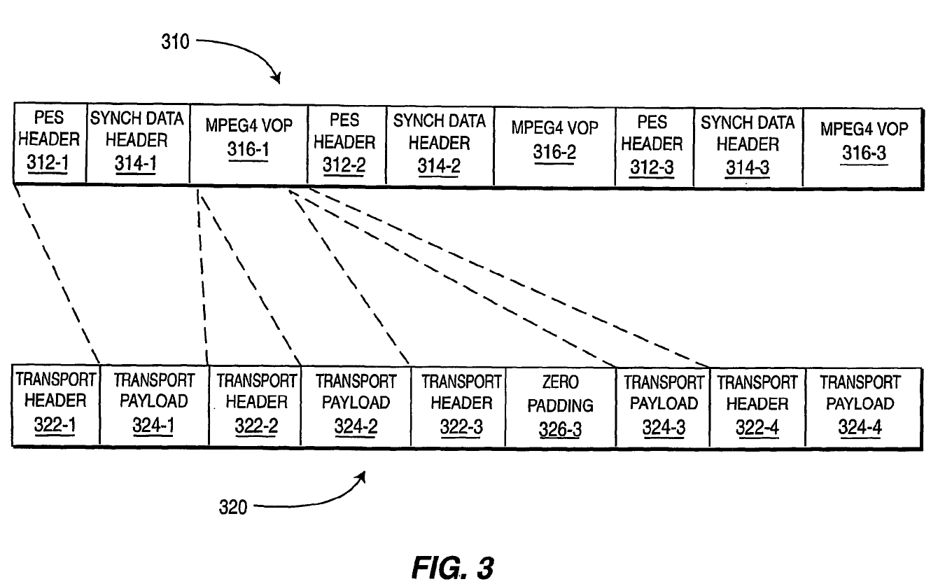

The process of encapsulating MPEG-4 video data into an MPEG-2 transport stream using Synchronous Data Streaming is illustrated schematically in FIG. 3. In the figure, a sequence of PES packets encapsulating MPEG4 VOPs 310 is shown juxtaposed above a sequence of MPEG-2 transport packets 320. Each of the PES packets 310 is comprised of a PES Header 312-i, a Sync Data Header 314-i and an MPEG-4 Video Object Picture (VOP) 316-i (where i represents a packet index number). In the MPEG-2 transport stream 320, each transport packet is constituted by a Transport Header 322-i and a Transport Payload 324-I (again, where i represents a packet index number).

In accordance with the principles of the present invention, the content of each PES packet is encapsulated into the payload portion of a sequence of transport packets, with zero padding added to the final transport packet in the sequence to fill any remaining bits in the payload portion of that final transport packet. Considering the illustrative case shown in the figure, a first portion of the initial PES packet, constituting PES Header 312-1, Sync Data Header 314-1 and a small portion of MPEG-4 VOP 316-1 is encapsulated into the payload portion of the first illustrated transport packet, Transport Payload 324-1. A next portion of MPEG-4 VOP 316-1 is then encapsulated into the payload portion of the next transport packet, Transport Payload 324-2. The remaining portion of MPEG4 VOP 316-1 is then encapsulated into the payload portion of the third transport packet, Transport Payload 324-3, with Zero Padding 326-3 added to the payload portion of that packet fill remaining bits.

As will be understood, the next PES packet, constituting PES Header 312-2, Sync Data Header 314-2 and MPEG-4 VOP 316-2, would then be encapsulated into a next sequence of transport packet payloads, beginning with Transport Payload 324-4.

The PES header contains a presentation time stamp (PTS) relative to the program clock reference (PCR) in the transport header. This PTS synchronizes the MPEG-4 video stream to system time. The audio PES packets also include an audio PTS relative to the transport layer PCR. Therefore, the audio and video are synchronized by having the same reference system time (the transport layer PCR).

The synchronous data header required for this mode of the ATSC data broadcast standard is included in every PES header (once per VOP). The synchronous data includes an 8 bit extension for the PTS field, and an optional data rate parameter.

For the Data Piping embodiment, it is again noted that ATSC Data Piping uses a mechanism that allows any type of data to be encapsulated in MPEG-2 transport packets without any restriction. The absence of restrictions allows for Data Piping to use more efficient methods for encapsulating MPEG-4 bit streams than using Synchronous Data Streaming. A presentation time stamp (PTS) is, however, still used for every video frame and every audio frame. To that end, an RTI based protocol is preferably used in this embodiment—i.e., each MPEG-4 VOP uses an RTP header with a time stamp. As is known, the RTP header contains a 32 bit time stamp parameter.

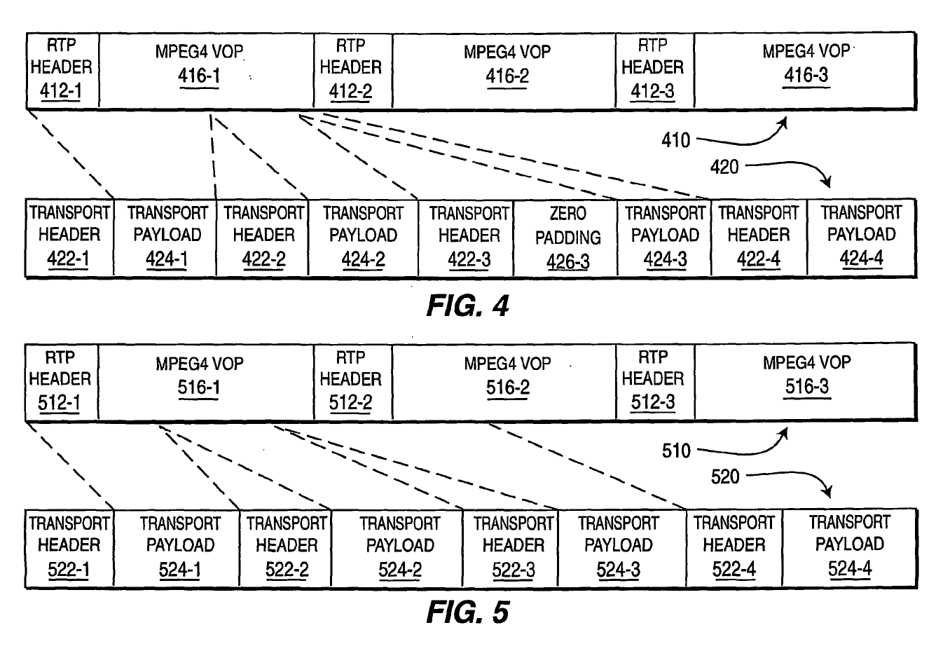

The process of encapsulating MPEG-4 video data into an MPEG-2 transport stream using Data Piping is illustrated schematically in FIG. 4. In the figure, a sequence of RTP packets encapsulating MPEG4 VOPs 410 is shown juxtaposed above a sequence of MPEG-2 transport packets 420. Each of the RTP packets is comprised of an RTP Header 412-i and an MPEG-4 VOP 416-i (where i represents a packet index number). In the MPEG-2 transport stream 420, each transport packet is constituted by a Transport Header 422-i and a Transport Payload 424-i (again, where i represents a packet index number). Similarly to the encapsulation method for Synchronous Data Streaming shown in FIG. 3, the content of each RTP packet is encapsulated into the payload portion of a sequence of transport packets, with zero padding added to the final transport packet in the sequence to fill any remaining bits in the payload portion of that final transport packet. Illustratively, as shown in the figure, RTP Header 412-1 along with a portion of MPEG-4 VOP 416-1 is encapsulated in Transport Payload 424-1, the next portion of MPEG-4 VOP 416-1 is encapsulated in Transport Payload 424-2, and a final portion of MPEG4 VOP 416-1 is encapsulated in Transport Payload 424-3. As also shown in the figure, Zero Padding 426-3 is used (as in the Synchronous Data Streaming case) at the transport payload level in order to align transport headers with the VOP header.

It should be noted that the precise mechanism for implementation of the PTS with RTP in the instant embodiment is merely illustrative, and the principles of the present invention are intended to contemplate any such mechanism that is compatible with the format defined by an RTP based system. In that regard, it is further noted that the RTP standard (IETF/RFC1889) includes a payload type (PT) parameter in the header. Therefore there are specific versions (other RFCs) defined for different applications. For example, IETF/RFC3016 specifies one possible way to encapsulate MPEG-4 audio and video into RTP packets. For an exemplary embodiment of the invention, this RFC3016 encapsulation approach (as discussed further below) may also be implemented. However, it should be understood that other known RFCs that define RTP packetization protocols for MPEG-4 are also within the contemplation of the invention, as well as such RTP packetization protocols for MPEG-4 as may later be developed. For example, there are new RFCs still in Draft form that define RTP packetization for MPEG-4, part 10 video, and which should be regarded as within the contemplation of the principles defining the present invention.

In the exemplary RFC3016 encapsulation approach described above, the time stamp parameter uses (in a default mode) a 90 KHz reference for its time stamp. This is consistent with the 90 KHz reference used in the ATSC standard. Therefore, the PCR and PTS fields would be based on the same clock period in this exemplary case. However, in alternative RTP implementations, the PTS field is not required to have the same reference clock as the ATSC 90 KHz clock. A conversion from one sample rate to another would be done for different reference clocks. The conversion is made as a direct ratio from one clock domain to another. For example, if the RTP protocol in use defined a PTS reference of an 80 KHz clock, then the PTS would be calculated as a product of the PCR clock and the fraction 8/9, and the PCR and PTS clocks would be reset synchronously to zero by the encoder.

In an alternate embodiment, the requirement for zero padding in the Data Piping embodiment described above is eliminated. In this alternative embodiment, RTP packets are encapsulated without the requirement of alignment with the transport packets. The encapsulation methodology for this alternative embodiment is illustrated schematically in FIG. 5, where like the approach of FIG. 4, a sequence of RTP packets encapsulating MPEG-4 VOPs 510 is shown juxtaposed above a sequence of MPEG-2 transport packets 520. As will be apparent from the figure, the structure of RTP packet stream 510 and transport packet stream 520 corresponds to the structure of the RTP and transport streams shown in FIG. 4. However, unlike the methodology of FIG. 4, no requirement is imposed for alignment of the transport headers with the VOP packet headers. Accordingly, bits from the beginning of a given VOP packet can be placed in the transport payload for the same transport packet containing ending bits of the preceding VOP packet, and thus the requirement for zero padding, as used in the FIG. 4 embodiment, is eliminated.

Note, however, that the approach of this alternative embodiment requires the creation of a method for locating the RTP headers of the unaligned packets. As an exemplary approach to this requirement, a pointer can be defined as the first byte of the transport payload, or an extension to the RTP header could include an optional pointer. Other such approaches will, however, be apparent to those skilled in the art, and all such approaches are intended to be encompassed within the scope of the invention.

When no packet alignment is used, the wasted channel capacity normally used for stuffing is eliminated. Therefore, on average 184/2=92 bytes per frame are saved. Depending on the size of the source material and the bit rate used, this savings could be important. In the case of High Definition, then the relative percentage of wasted bandwidth is small. However, when the method of the invention is used for smaller resolutions or frame rates, it is possible that only a few transport packets per frame are needed. In this case, the savings can be 20-30% of the channel bandwidth. It is to be noted, however, that this bandwidth savings approach is not available with the Synchronous Data Streaming embodiment, since that format enforces the use of PES.

Numerous modifications and alternative embodiments of the invention will be apparent to those skilled in the art in view of the foregoing description. In particular, it should be understood that the use of the MPEG-4 coding/compression standard to illustrate the principles of the invention is only a preferred embodiment. The application of the methodology of the invention to other or additional advanced video compression methodologies is intended to be within the contemplation of the invention.

Accordingly, this description is to be construed as illustrative only and is for the purpose of teaching those skilled in the art the best mode of carrying out the invention and is not intended to illustrate all possible forms thereof. It is also understood that the words used are words of description, rather than limitation, and that details of the structure may be varied substantially without departing from the spirit of the invention and the exclusive use of all modifications which come within the scope of the appended claims is reserved.

1. In a system for transmission of video and audio information, wherein the system is constrained to operate pursuant to a given standard, including application of a given coding methodology, a method for transmitting said information using a coding methodology that is independent of said given coding methodology, the method comprising the steps of:
encoding said information into a plurality of increments encoded according to the independent coding methodology; and
encapsulating the encoded information increments into a payload portion of transmission packets established according to said given standard.

2. The method of claim 1 wherein said encapsulated encoded information increments maintain control and timing information for said given coding methodology.

3. The method of claim 1 wherein said given standard is one promulgated by the Advanced Television Systems Committee and said given coding methodology is MPEG-2.

4. The method of claim 1 wherein the independent coding methodology is MPEG-4.

5. The method of claim 1 wherein information is transmitted by said transmission system according to a Synchronous Data Streaming methodology.

6. The method of claim 1 wherein information is transmitted by said transmission system according to a Data Piping methodology.

7. The method of claim 6 wherein said information encoded by said independent coding methodology is encapsulated into packets established according to Real Time Protocol.

8. The method of claim 7 wherein a header of said encoded information is aligned with a transport header for given packets.

9. The method of claim 8 wherein said alignment of said information header and said transport header is effected by use of zero stuffing.

10. The method of claim 7 wherein said packet encapsulation of said encoded information is independent of a transport time reference.

11. An encoding/multiplexing system arranged to encode video and audio information according to a given standard, including application of a given coding methodology, and to package said encoded information into one or more transport streams, the encoding/multiplexing system comprising:
an independent information channel operative to process an information stream encoded into a plurality of increments based on a different coding methodology than said given coding methodology;
means for encapsulating encoded information increments of said information stream into a payload portion of transmission packets established according to said given standard.

12. The encoding/multiplexing system of claim 11 wherein said means for encapsulating further operates to maintain control and timing information for said given coding methodology.

13. The encoding/multiplexing system of claim 11 wherein information is transmitted according to a Data Piping methodology, and further wherein said encoded information increments encoded by said different coding methodology are encapsulated into packets established according to Real Time Protocol.

14. The encoding/multiplexing system of claim 13 wherein a header of said encoded information is aligned with a transport header for given packets.

15. The encoding/multiplexing system of claim 14 wherein said alignment of said information header and said transport header is effected by use of zero stuffing.

16. The encoding/multiplexing system of claim 13 wherein said packet encapsulation of said encoded information increments is independent of a transport time reference.

17. A decoder comprising:
a processing means arranged to receive encoded information at an input, said encoded information being encoded and transmitted according to a given standard, including application of a given coding methodology, and to output a signal substantially representative of said encoded signal prior to encoding;
wherein said processing means is further operative to receive encoded information encoded by a coding methodology independent of said given coding methodology, and to output a signal substantially representative of said independently encoded signal prior to encoding; and
further wherein incremental portions of said independently encoded information received by said second processing means are encapsulated into a payload portion of transmission packets established according to said given standard.

18. The decoder of claim 17 further wherein said incremental portions of said independently encoded information received by said second processing means maintain control and timing information for said given coding methodology.

19. The decoder of claim 17 wherein information encoded by said independent coding methodology and received by said processing means is transmitted to said decoder according to a Data Piping methodology, and further wherein said incremental portions of said independently encoded information are encapsulated into packets established according to Real Time Protocol.

20. The decoder of claim 19 wherein a header of said independently encoded information is aligned with a transport header for given transmission packets.

21. The decoder of claim 20 wherein said alignment of said information header and said transport header is effected by use of zero stuffing.

22. The decoder of claim 19 wherein said packet encapsulation of said independently encoded information increments is independent of a transport time reference.
